(19) United States
(12) Patent Application Publication
(10) Pub. No.: US 2008/0222160 A1
(43) Pub. Date: Sep. 11, 2008

(54) Method and system for providing a program for execution without requiring installation

(76) Inventors: Craig MacDonald, Kanata (CA); Donn Rochette, Fenton, IA (US); Alois Liebl, Knoxville, TN (US)

Correspondence Address: KENYON & KENYON LLP, ONE BROADWAY, NEW YORK, NY, 10004, US

(21) Appl. No.: 12/075,842

(22) Filed: Mar. 13, 2008

Related U.S. Application Data
(63) Continuation-in-part of application No. 11/380,285, filed on Apr. 26, 2006.
Application No. 11/380,285 is a continuation-in-part of application No. 10/946,536, filed on Sep. 21, 2004.
Application No. 11/380,285 is a continuation-in-part of application No. 10/939,903, filed on Sep. 13, 2004.
(60) Provisional application No. 60/676,998, filed on May 2, 2005.
(60) Provisional application No. 60/504,213, filed on Sep. 22, 2003.
(60) Provisional application No. 60/502,619, filed on Sep. 15, 2003.
(60) Provisional application No. 60/512,103, filed on Oct. 20, 2003.

(51) Int. Cl. G06F 7/06; G06F 17/30

(52) U.S. Cl. 707/10; 707/E17.032

(57) ABSTRACT

In a method and system for performing a task for a software application that facilitates implementation of the software application with minimized installation requirements, in response to a request by the software application for a local system file of an operating system used for execution of the software application, a processor may redirect the request to access a file stored in a capsule environment together with the software application, where the redirecting includes: updating a table, which a local kernel of the operating system accesses for calling a system call handler, to include a pointer to a filter handler instead of the system call handler, the filter handler, when implemented, passing modified values to the system call handler; and/or causing an application library to redirect a request thereto to a filter library for communicating with the local kernel.

### CROSS-REFERENCE TO RELATED APPLICATIONS

This application is a continuation-in-part application of U.S. patent application Ser. No. 11/380,285, filed Apr. 26, 2006, entitled ‘System Including Run-Time Software To Enable A Software Application To Execute On An Incompatible Computer Platform,’ which is incorporated herein by reference in its entirety. U.S. patent application Ser. No. 11/380,285 claims priority from U.S. Provisional Patent Application No. 60/676,998, filed May 2, 2005; is a continuation-in-part application of U.S. patent application Ser. No. 10/946,536, filed Sep. 21, 2004, entitled ‘Computing System having User Mode Critical System Elements as Shared Libraries,’ which claims priority from U.S. Provisional Patent Application No. 60/504,213, filed Sep. 22, 2003, entitled ‘User Mode Critical System Element as Shared Libs’; and is a continuation-in-part application of U.S. patent application Ser. No. 10/939,903, filed Sep. 13, 2004, entitled ‘System for Containerization of Application Sets,’ which claims priority from U.S. Provisional Patent Application No. 60/502,619, filed Sep. 15, 2003, and from U.S. Provisional Patent Application No. 60/512,103, filed Oct. 20, 2003, all of which are incorporated herein by reference in their entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to deployment of software in a manner that provides for its execution without installation and/or configuration in a host platform.

### BACKGROUND INFORMATION

Computer systems are designed in such a way that application programs share common resources, including, for example, libraries and hardware resources. It is traditionally the task of an operating system to provide a mechanism to safely and effectively control access to shared resources required by application programs. This is the foundation of multi-tasking systems that allow multiple disparate applications to co-exist on a single computer system.

In order for the operating system to manage the libraries and provide access to the libraries to the application programs, an installation procedure is initially performed prior to a first running of the application programs on the operating system. The installation includes registering the application program and its required files with the operating system and adding to and/or modifying the libraries of the operating system so that the libraries include the files in a form usable by the application programs.

Aside from installation, prior to running an application program for the first time, a configuration procedure is often performed in which to set program preferences.

The installation and the configuration can take a long time to perform. This may be an inconvenience, for example, where a program is distributed by an entity to many of its employees and application operators, and can result in inefficiencies particularly where many of the employees and operators are to use the same configurations.

Furthermore, computer software applications are typically designed to run on a specific computer platform, and will not run on one for which it is not designed. Therefore, programmers desirous of their software to be used on a plurality of different incompatible computer platforms, have to design specific versions of their software that are compatible with each specific computer platform and operating system on which it is to be installed.

### SUMMARY OF THE INVENTION

It is an object of this invention to provide a system and method whereby one or more software applications can be run or executed on an incompatible computer platform on which, heretofore, the applications could not be run. This provides a significant advantage. It allows a single application that was only executable on a specific computer platform to now be used by a plurality of different computer platforms. Special software applications need not be written, taking weeks, months or years to create and deploy. Now, in accordance with this invention, by providing linkages to libraries and applications, and providing a secure capsule run time environment, software applications can be run on systems where they could not before.

It is an object of this invention to provide a system and method which offers compatibility between some software applications and computer platforms that are not otherwise compatible.

It is an object of this invention to provide a system and method via which application programs are provided in a manner that provides for plug-n-play integration with a processing environment without a time-consuming installation, e.g., such that installation is not required.

It is an object of this invention to provide a system and method for providing multiple copies of a once configured application program for distribution to a plurality of users without re-configuration.

In accordance with the invention there is provided a system and method for enabling a first software application, which is designed for execution on a first computer platform, to be executed on an incompatible computer platform in which the first software application is not intended to execute. The system and method may provide a secure substantially isolated capsule environment for execution of the first software application on the incompatible computer platform. The first software application may include an object executable by a local operating system of the incompatible computer platform for performing a task related to a service. The incompatible computer platform may include a processor, an operating system including a local kernel residing on the incompatible computer platform, and a set of associated local system files compatible with the local kernel and the processor of the incompatible computer platform. The system may include: a) a set of associated capsule-related files, which include a first group of files that include the first software application, designed to execute on the first computer platform, and a second group of files that are distributed with or are specific to an operating system required to execute the first software application, where, in operation, the associated capsule-related system files are used in place of the associated local system files normally used to perform the same task and which are resident on the incompatible computer platform as part of the operating system, the set of associated capsule-related system files provided for use by the first software application within the capsule environment; and b) capsule runtime software for managing a dynamic state and file location of the first software application, the capsule runtime software including a filter module and at least one application library for filtering system service requests made by the first software application and for providing values from the at least one application library to modify values that otherwise would have been returned by the local operating system in the absence of said filtering a system service request from the first software application. Execution of the first software application may require access of files from the capsule-related files in place of operating system files. The capsule specific values may be provided instead of values related to the identity of the incompatible computer platform.

In an example embodiment of the present invention, the filter module may be implemented as a kernel module and may include instructions which, when executed, cause a processor to update a table accessed by the local kernel and which includes pointers to handlers for executing system calls, e.g., for obtaining files. The update may modify the table to include a separate handler assigned to the capsule and which, when implemented by the kernel, obtains the files in the capsule rather than files in the directories of the operating system.

In an example embodiment of the present invention, the filter module may include instructions which, when executed, cause a processor to modify a first library of the first software application to point to a second library included in the capsule. Thereafter, during execution of the first software application, when the software application accesses the first library in order to obtain one of the operating system files, the first library points to the second library, which, in turn, provides a modified path referencing a capsule-included file instead of an operating system file to the kernel. Using the modified path, the kernel accesses a handler for obtaining the file referenced in the modified path, so that the capsule-included file, rather than the operating system file, is returned for use by the first software application.

For example, for the exemplary embodiment according to which the table is modified, the filter module may be executed in a kernel mode; for the exemplary embodiment according to which the first library is modified to point to the second library, the filter module may be executed in a user mode.

By way of example, the system and method in accordance with an example embodiment of the present invention may be capable of allowing an application designed to work with Solaris version 2.6 to be placed into a capsule on a Solaris 9 platform so that it can function within the Solaris 9 platform. Similarly, an application designed for execution with Solaris version 8 may be placed in a capsule on a Solaris 9 platform. Similarly, a system designed to work with Red Hat Enterprise Linux 4 (EL4) may be placed in a capsule on a Suse Linux Enterprise Server 9 (SLES 9) or vice versa. Similarly, an application designed to work with Red Hat Enterprise Linux 3 (EL3) may be placed in a capsule on a Suse Linux Enterprise Server 9 (SLES 9) or vice versa. Similarly, an application designed to work with Linux Fedora Core 4 may be placed in a capsule on a platform using Suse Pro 9 or vice versa.

In an example embodiment of the present invention, a system and method is provided which may enable a first software application, which is designed for execution on a first computer platform, to be executed on an incompatible computer platform in which the software application is not intended to execute. The system may include: a first group of files that are distributed with or are specific to the first software application and a second group of files that are distributed with or are specific to an operating system associated with the first computer platform; means for isolating the first group of files within a capsule, from other software applications so as to provide an isolated first group of capsule files inaccessible to the other software applications external to the capsule; and capsule runtime software for managing a dynamic state and file location of the isolated first group of files, the capsule runtime software including a filter module and at least one application library for modifying the behavior of a local operating system residing on the incompatible computer platform, so that execution of the first software application requires access of at least some of the isolated first group of files in place of operating system files and providing capsule specific values instead of values related to the identity of the incompatible computer platform.

In an example embodiment of the present invention, in a system having a computer platform having an operating system for executing a compatible software application including a kernel, a method is provided for executing an incompatible software application, comprising the steps of: providing to the computer platform for execution by the computer platform one or more encapsulated files, including the incompatible software application and runtime software for filtering requests to the kernel from the incompatible software application and or associated library files, that would otherwise result in a malfunction of the incompatible software application and providing information from files within the encapsulated files so as redirect execution to files within the capsule that allow the incompatible software application to successfully execute.

In an example embodiment of the present invention, a system is provided, for enabling a first software application, which is designed for execution on a first computer platform, to be executed on an incompatible computer platform in which the first software application is not intended to execute, said first software application including an object executable by a local operating system of the incompatible computer platform for performing a task related to a service, the incompatible computer platform including a processor, an operating system including a local kernel residing on the incompatible computer platform, and a set of associated local system files compatible with the local kernel and the processor of the incompatible computer platform. The system may include: a) a set of first files, comprising a first group of files that include the first software application, designed to execute on the first computer platform and a second group of files that are distributed with or are specific to an operating system required to execute the first software application, where, in operation, said second group of files are used in place of the associated local system files normally used to perform the same task, which are resident on the incompatible computer platform as part of the operating system, said second group of files for use by the first software application; and b) runtime software for managing a dynamic state and file location of the first software application, the runtime software including a filter module resident in kernel mode and at least one application filter library resident in user mode for filtering one or more system service requests made by the first software application and for providing values from the at least one application filter library which is provided in addition to the local operating system libraries to modify values that otherwise would have been returned by the local operating system in the absence of said filtering one or more system service requests from the first software application, where execution of the first software application requires access of files from first set of files in place of operating system files and where predetermined values are provided instead of values related to the identity of the incompatible computer platform.

In an example embodiment of the present invention, a system and method is provided for enabling a software application, which is designed for installation for management by an operating system, to run on a computer platform without the installation. The system and method may provide a secure substantially isolated capsule environment for execution of the software application on the computer platform. The software application may include an object executable by the operating system of the computer platform for performing a task related to a service. The computer platform may include a processor, the operating system including a local kernel residing on the computer platform, and a set of associated local system files compatible with the local kernel and the processor of the computer platform. The system may include: a) a set of associated capsule-related files, which include a first group of files that include the software application, designed to execute on the computer platform, and a second group of files that are distributed with or are provided for an operating system and which are required to execute the software application, where, in operation, the associated capsule-related files are used in place of the local system files normally used to perform the same task and which are resident on the computer platform as part of the operating system, the set of associated capsule-related system files provided for use by the software application within the capsule environment; and b) capsule runtime software including a filter module and at least one application library for filtering system service requests made by the software application and for providing values from the at least one application library to modify values that otherwise would have been returned by the local operating system in the absence of said filtering of system service requests from the first software application. Execution of the software application may require access of files from the capsule-related files in place of operating system files. The capsule specific values may be provided instead of values related to the operating system files.

In an example embodiment of the present invention, a system and method may enable a software application designed for installation for management by an operating system, to run on a computer platform without the installation. A hardware-implemented memory device may store a capsule. The capsule may include the software application, capsule-related files, and capsule runtime software. The capsule runtime software may include a filter module. The computer platform may include the operating system and local files for access to which the software application is designed. The filter module may be configured to redirect requests by the software application for accessing the local files so that the capsule-related files are accessed instead.

According to an exemplary implementation of this embodiment, the capsule may include one or more first libraries the software program is designed to access in order to obtain the local files and may further include one or more capsule libraries. The filter module may be configured such that a processor executing the filter module modifies at least one of the first libraries to include pointers to the one or more capsule libraries. The operating system may include a local kernel. During execution of the software program, the software program may access the modified at least one first library, which may point to a corresponding one of the one or more capsule libraries. Responsive to the access of the corresponding capsule library, the corresponding capsule library may pass a path to the local kernel. The path may point to one or more of the capsule-related files. Responsive to receipt of the path, the local kernel may access a handler used for obtaining the one or more capsule-related files.

According to an alternative exemplary implementation of this embodiment, the capsule may include one or more libraries the software program is designed to access in order to obtain the local files. The operating system may include a local kernel. The filter module may be configured such that a processor executing the filter module modifies a table that references handlers to refer to different handlers. During execution of the software program, the software program may access the one or more libraries. The libraries may responsively provide a path to the local kernel. The local kernel may responsively refer to the modified table and instantiate one of the different handlers referenced by the modified table. The instantiated different handler may interpret the path as a request for one of the capsule-related files instead of a corresponding local file referenced by the path.

### BRIEF DESCRIPTION OF THE DRAWINGS

FIG. 1 is a block diagram depicting a basic view of a virtualized software application, using Java/J2EE or NET services, and juxtaposed, is shown a native software application based on C++ services.

FIG. 1a illustrates the full application model showing an example embodiment of the present invention alongside an application based on current art.

FIG. 2 is a prior art schematic diagram extending the application model to include application state.

FIG. 3 is a prior art schematic diagram extending the application model to show how system services interact with applications.

FIG. 4 is a diagram illustrating a basic capsule creation model, according to an example embodiment of the present invention.

FIG. 5 is a diagram illustrating system service filters in the context of an overall application model, according to an example embodiment of the present invention.

FIG. 6 is a diagram that illustrates the behavior of one aspect of system service filters, according to an example embodiment of the present invention.

FIG. 7 is a capsule state diagram, which describes a sequencing throughout a capsule life cycle, according to an example embodiment of the present invention.

FIG. 8 illustrates steps taken to create and deploy a capsule, according to an example embodiment of the present invention.

FIG. 9 illustrates a system services filter model, according to an example embodiment of the present invention.

FIG. 10 shows that a capsule file set may include files specific to or delivered with an application in addition to files that are specific to or delivered with an OS, according to an example embodiment of the present invention.

FIG. 11 is a block diagram representing a Capsule Runtime, according to an example embodiment of the present invention.

FIG. 12 is a prior art depiction of the anatomy of a software application.

FIG. 13 presents a file oriented view of an application capsule, according to an example embodiment of the present invention.

### DETAILED DESCRIPTION OF EXAMPLE EMBODIMENTS

The following definitions are used herein:
Computing platform: a computer system with an instance of a fully functional operating system installed.
Capsule: an aggregate of files required to successfully execute a software application on a computing platform. A capsule is not a physical capsule but a grouping of associated files, which may be stored in a plurality of different locations that is to be accessible to, and for execution on, a single computer platform or one or more servers. The term ‘within a capsule’ or ‘encapsulated within a capsule,’ used within this specification, is to mean ‘associated with a capsule.’ A capsule includes one or more applications and associated system files for use in executing the one or more applications; but capsules need not include a kernel; each capsule of files has its own execution file associated therewith for starting one or more applications. In operation, each capsule utilizes a kernel, e.g., resident on the server and that is part of the OS on which the capsule is running, to execute its applications. Files ‘within a capsule’ are generally not accessible by application programs executing on the same computer platform in another capsule. Notwithstanding a shared capsule purposefully allows the sharing of specific files.
Secure application capsule: an environment where each application set has individual control of some critical system resources and/or where data within each application set is insulated from effects of other application sets.
System files: files provided within an operating system and which are available to applications as shared libraries and configuration files.

By way of example, Linux Apache uses the following shared libraries, supplied by the OS distribution, which are ‘system’ files:
/usr/lib/libz.so.1
/lib/libssl.so.2
/lib/libcrypto.so.2
/usr/lib/libaprutil.so.0
/usr/lib/libgdbm.so.2
/lib/libdb-4.0.so
/usr/lib/libexpat.so.0
/lib/i686/libm.so.6
/lib/libcrypt.so.1
/lib/libnsl.so.1
/lib/libdl.so.2
/lib/i686/libpthread.so.0
/lib/i686/libc.so.6
/lib/ld-linux.so.2

Apache uses the following configuration files, also provided with the OS distribution:
/etc/hosts
/etc/httpd/conf
/etc/httpd/conf.d
/etc/httpd/logs
/etc/httpd/modules
/etc/httpd/run

By way of example, together these shared library files and configuration files may form system files provided by the operating system. There may be any number of other files included as system files. Additional files might be included, for example, to support maintenance activities or to start other network services to be associated with a capsule.

One of the difficulties with a cohesive model of software application behavior or execution is that software applications are generally multi-layered and there are multiple facets to dependencies therebetween. One way to view a software application is from the perspective of its place within the computing platform, the salient elements of the software application, and how the elements interact with the operating system (OS). This architectural view affords a clearer understanding of application requirements and dependencies.

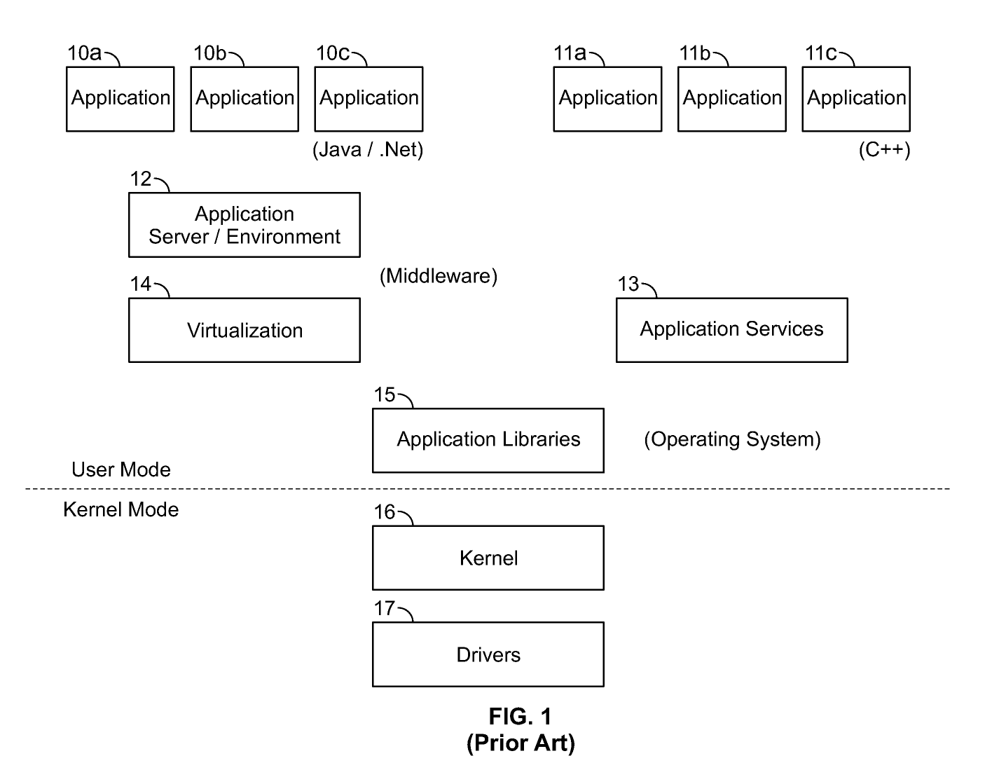

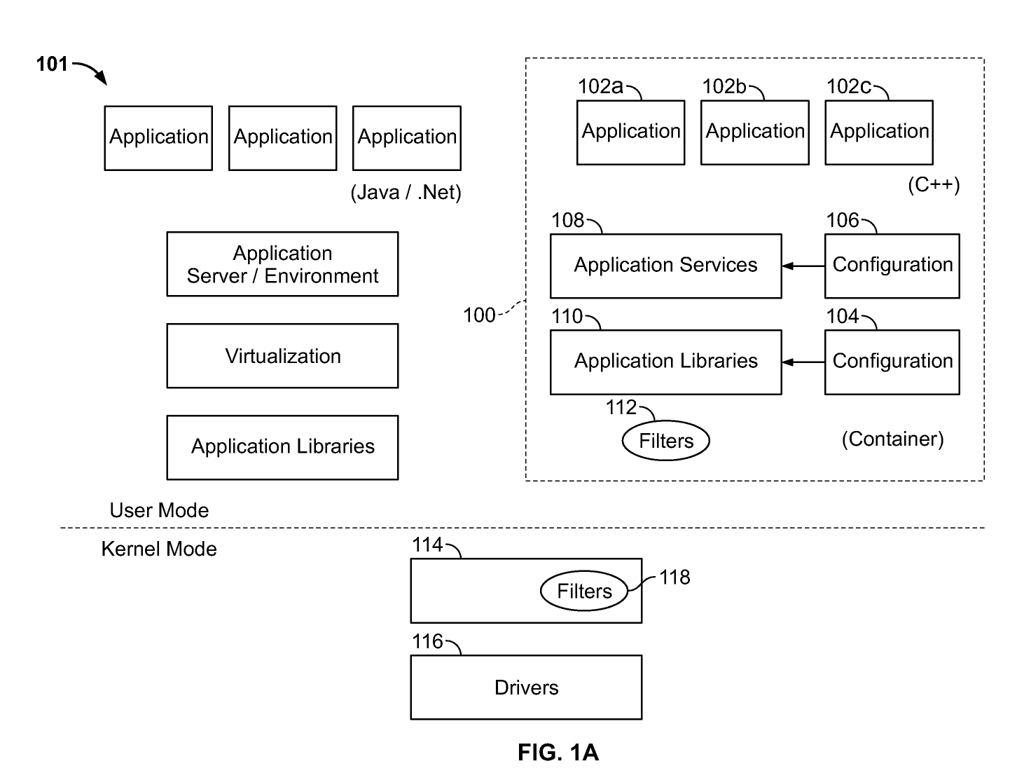

Prior art FIG. 1 illustrates a basic view of two types of software applications. One is a virtualized application, using Java/J2EE or .NET services, and the other is a native application based on C++ services. In FIG. 1, applications 10a, 10b, and 10c represent Java applications and 11a through 11c represent C++ applications. The applications 11a through 11c can be executed directly by the computer. The execution of the applications requires use of application services 13 and libraries 15 to access hardware services exported through the kernel 16 and drivers 17. Applications 10a through 10c differ in that they include byte codes that cannot be executed directly on the computer. Through the use of virtualization 14, the byte codes are converted into instructions that can be executed on the computer. The application server environment 12 provides an extended set of services available for use by 10a through 10c. All OS services, whether residing in the kernel or in user mode, are shared among all processes hosted by a kernel instance. With reference to FIG. 1, with both Java and C++ application types, processes interact with shared system services through application libraries or interact directly with the kernel in some rare instances. Application processes utilize kernel services to perform operations outside of their process context. This includes access to hardware, communication with other processes hosted by the same kernel, communication outside the platform, allocation of memory. Any processes that extend or transcend the given process context passes through the kernel. These kernel services are accessed through system calls.

Turning now to FIG. 1a, an aspect of an example embodiment of the present invention is shown compared with traditional application models, as used in current art. FIG. 1a is shown divided into two parts, wherein 101 shows applications outside of a capsule environment and 100 illustrates the execution of one or more applications within a capsule environment. It can be seen that application binary files 102a, 102b, and 102c make use of application libraries 110 and application services 108. Included in a capsule environment are system configuration 106 and application configuration 104. Capsule runtime services support system service filters both in user mode, e.g., filters 112, within the capsule environment, and in kernel mode, e.g., filters 118, as a kernel module, as shown in 118.

FIG. 1a presents a process view of an application capsule operation according to an example embodiment of the present invention. The one or more applications, 102a, 102b, and 102c, utilize application services 108 and access operating system services through the use of application libraries 110. Applications executing within 100, a capsule environment, may utilize system service filters 112. The system service filters 112 are not applied to applications executing outside a capsule environment such as those depicted in 100. System service filters applied to applications in 101 may allow processes to be tracked within a capsule, as well as allowing application information to be monitored and modified when required.

An example embodiment of the present invention may allow for the provision of a series of application capsules, wherein more than one type of capsule may be required due to varying isolation requirements between application types. In a desktop application isolation may be limited to a segregated file name space. A sever based application may benefit by using a completely distinct identity with respect to the underlying OS and other applications. In this instance a series of application capsules are provided. In accordance with this invention the term capsule continuum is used hereafter to describe multiple types of application capsules.

Application isolation may be provided in accordance with two factors:

1) Capsule file set content: the files placed in a local capsule file name space may define which files will be used local to the capsule. The files located in a capsule file set may be used by application processes executing in a capsule environment instead of files located in the underlying OS.

2) System service filters: by defining which system services are filtered and the specific behavior or function of the filter, the degree to which the application is isolated from the OS and other applications may be controlled.

The two factors governing isolation can be viewed as controls that can be adjusted independent of each other to control the degree of isolation applied to an application capsule. A capsule continuum may be created as multiple types of capsules are created. In one embodiment of the invention, three capsule types are supported. These are basic, advanced, and virtualized capsules. These capsule types may represent a specific instance of application isolation. In analogous form, they represent a given setting of the two adjustable controls.

While FIG. 1 illustrates how processes within an application 11a, 11b, and 11c interact with the broader system 15, 16, and 17 and with each other, it does not illustrate the management of their state. At all levels of an application stack, configuration is generally required. At higher levels of the application stack, the configuration tends to be static or predetermined, originating from files. Even in instances where scripts or applets are run to configure specific elements, related services most often acquire their input from configuration files. In some instances, configuration is dynamic wherein a user must interactively provide information in order for the application to proceed. The lower levels of the application stack often require both static and dynamic configuration. Parameters specific to the OS, network, or other facets of the underlying platform and infrastructure are often times dynamic. Elements that an application may obtain dynamically include an IP address, hostname, MAC address, system ID, and more.

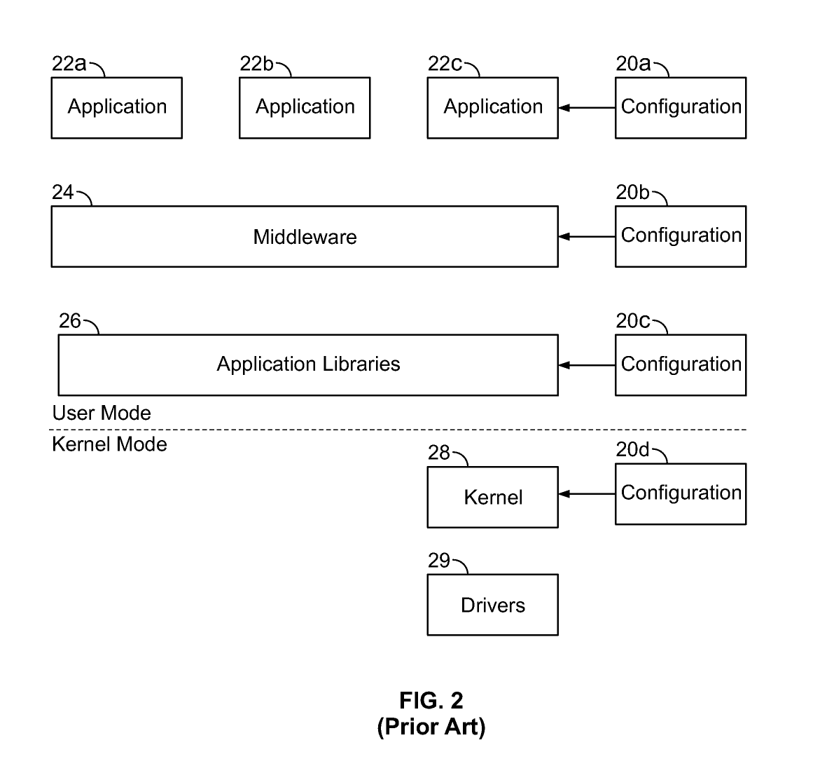

FIG. 2 extends the application model to include configuration elements 20a, 20b, 20c, and 20d. Configuration elements are applied to the application stack at all levels, creating state dependencies. The applications 22a, 22b, and 22c are shown using extended services described as middleware 24. OS services are exported through the use of application libraries 26. These libraries 26 support access to kernel services 28. The kernel controls access to drivers 29. Configuration is applied to the software stack at all levels. Applications 22a, 22b, and 22c receive configuration in the form of user defined values as shown in 20a. Middleware configuration is applied in 20b. Application library configuration is applied in 20c. The kernel is configured as shown in 20d.

Software applications provided with an OS distribution are dependent on system services. These system services may take the form of low-level libraries or for example a service may be the loader that places images in memory and manages shared libraries or DLLs. These services may include helper applications, scripts, and/or language environments. Where network services are required in conjunction with an application, more often with server applications, a number of processes external to the application itself may be required to support capabilities like RPCs, network mount points, remote management and so forth. By way of example, where local user interaction with an application is utilized, the UNIX environment may be required. This often includes an SSH or Telnet service, a shell, and most of the UNIX command set.

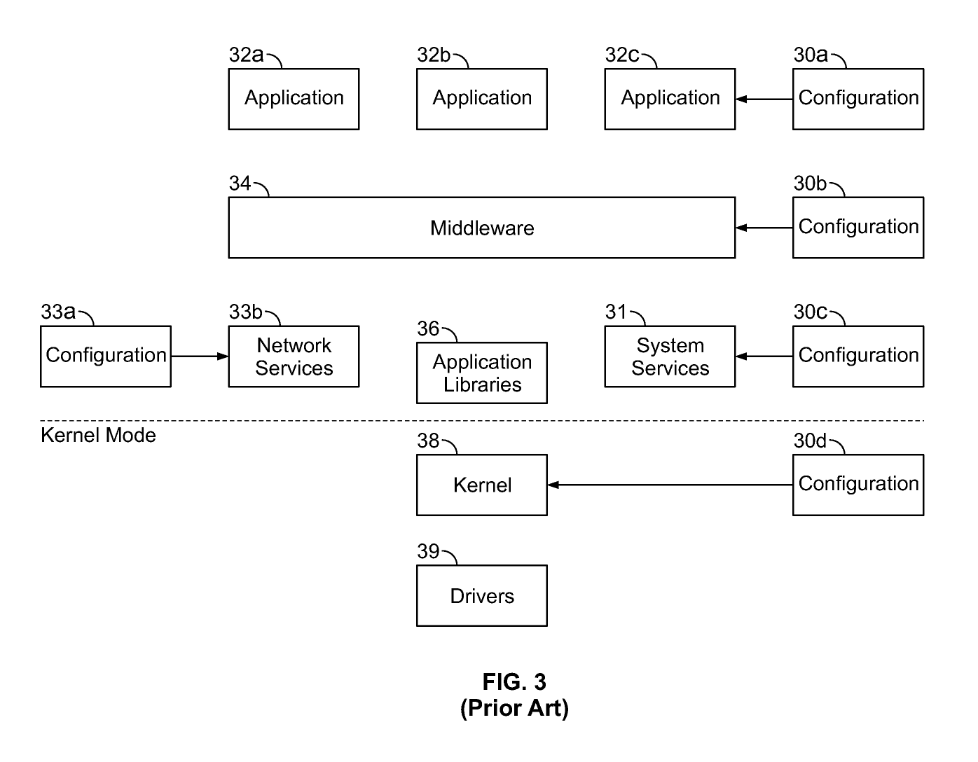

FIG. 3 expands the application model to include dependencies on system services 33b and 31a. Applications 32a, 32b, and 32c are C++ applications which utilize middleware services 34. Access to OS services is provided by application libraries 36. The kernel 38 controls access to hardware services including all drivers 39. Configuration is applied to the software stack as shown in 30a, 30b, 30c, 30d, and 33a. Extended OS services include network services 33b and system services 31a. Network services 33b are exemplified by capabilities such as RPC services. System services 31a include capabilities such as logging.

In accordance with an example embodiment of the present invention, in some instances, mostly with server applications, it may be useful for the application capsule to include network services 53b, different than those of the underlying OS or even a replication of those of the underlying OS, i.e., services that execute in the context of the capsule, independent of like services that may or may not execute outside a capsule context, in the underlying OS, or in another capsule. This can result, for example, in a capsule environment hosting its own instance of a port map service. Many applications only require low-level system services. A compiler, for example, may only require a loader and the file system. Such an application is not dependent on external processes as system services.

System services, where required, are readily started in the context of a capsule. In one embodiment of the invention, system services are started in a capsule context by starting a first process in the capsule context that is a script which in turn starts other system services contained within the capsule. This has the effect of starting the first script and any child processes, including system services, in the capsule context.

In accordance with an example embodiment of the present invention, application capsules provide independence from the underlying infrastructure by allowing both static and dynamic elements of an application state to be kept local to the application. Local state may be accomplished via file encapsulation and system service filters.

Files used by the application may be encapsulated and made available to processes that are part of the application independent of the files supplied by the OS distribution. This creates a capsule file set available to processes that execute in the capsule environment. FIG. 10 illustrates that a capsule file set 1003 includes files specific to the application 1001, or applications that are being encapsulated, and placed in a capsule as well as files that are specific to the underlying OS 1002. Any number of files could be placed in a capsule file set 1003. Depending on desired behavior, this could include the majority of files included in an OS distribution or a small set required for specific application execution. Application specific files 1001 are those files delivered with or specific to a given application. OS specific files 1002 are those files that are delivered with or specific to the OS. A subset or all of these files 1002 used for the capsule's application are placed in the capsule file set 1003. The capsule runtime 1004 provides access to the capsule file set 1003 as processes execute in a capsule context.

A capsule file set is created through the use of a Capsule Build Tool (CBT). The CBT enables automated discovery of the files used by an application as well as a manual file dispatch capability. This is accomplished by running a test instance of the software application and monitoring, tracking, and recording all occurrences of files requested in the execution of the application. Any file can be dispatched as follows:

Include: the file is included in the capsule file set. As such, it will be used by processes executing in the capsule environment rather than referencing the underlying OS for the file.

Exclude: the file is not used. If a process executing in the capsule environment references the file, it will not be found, even if the file is present in the underlying OS.

Share: the file will be found in a shared capsule. This represents a capsule file set that can be shared among multiple capsules.

Mount: the file will be found through a mount point defined in the underlying OS.

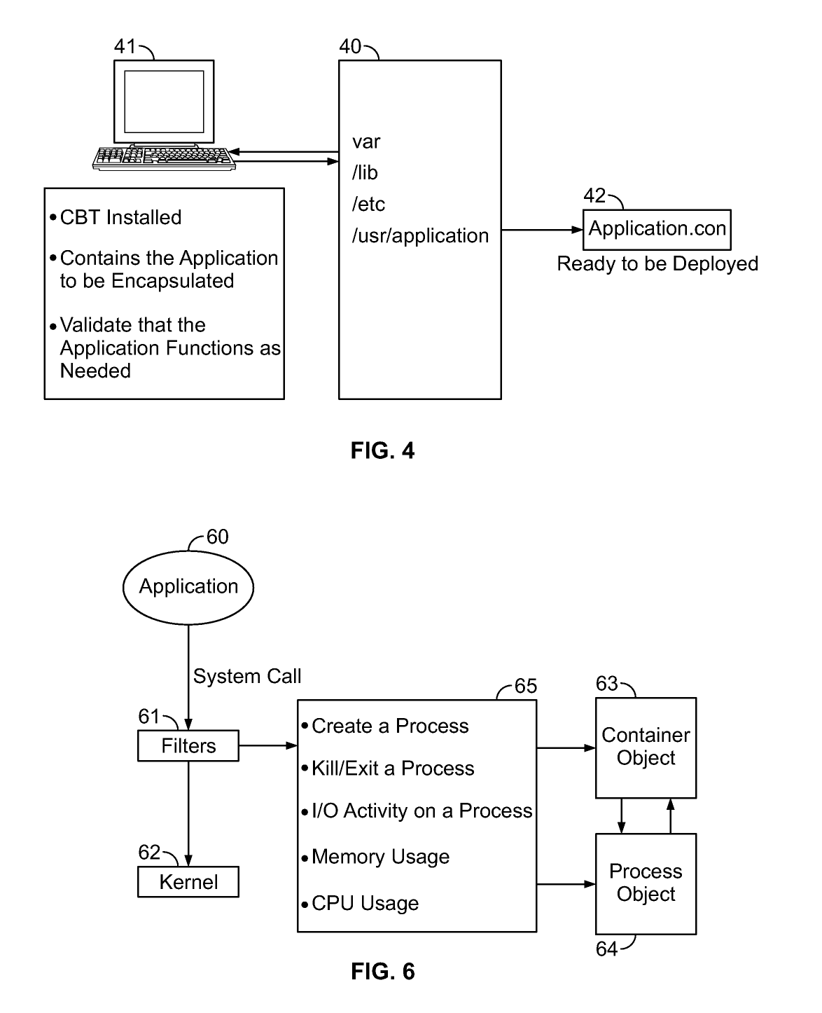

FIG. 4 illustrates how the CBT interacts with a computer platform 41 to discover and dispatch a capsule file set 40. The creation tool CBT may be installed on a source platform 41 that includes an application to be placed in a capsule. The capsule creation process performed on 41 results in the creation of a capsule file set 40. Once completed and validated, the capsule file set 40 is archived in a single capsule file 42 that is preferably encrypted and compressed.

Capsule runtime (CR) software may be implemented for the operation of application capsules and may be installed on a platform that will host a capsule. System service filters, deployed with the CR software 1004, may ensure that applications executing in a capsule context use the appropriate files from the capsule file set 1003. The CR software 1004 is used to manage dynamic application state. It does this by filtering system services. There are three types of system service filters:
a) Process tracking: all processes are identified as being associated with a given capsule or with the underlying OS.
b) Information: resources used by all processes within a capsule environment are tracked and made available. In addition, application behavior, based on known profiles, can be tracked and any variance reported.
c) Managed state: certain values returned by system services can be modified such that application isolation is maintained. This includes ensuring that processes executing in a capsule environment use files based on the associated capsule file set. This type of filter will also include operations that ensure capsule identity, such as a unique IP address and hostname.

System service filters may be used in both kernel mode and user mode. For example, the system service filters may be used only in kernel mode, only in user mode, or in a combination of user and kernel modes.

In kernel mode, the system service filters are embodied in a loadable kernel module. When the kernel module is loaded, the initialization procedure locates the kernel system call table. A specific system service filter is installed by placing a handler in the corresponding system call table entry. The original system call handler is saved for use by the system service filter. When the specific system call in question is executed in the kernel, the system service filter handler is called before the original kernel system call handler.

In user mode, the system service filters are embodied in a shared library. The shared library is loaded along with the software application executable objects. The system service filter is executed before the original system service. This type of filtering of a system service in user mode is accomplished using a number of well known capabilities. These include, but are not limited to, library preload services, system call trace facilities, and an upcall mechanism. Library preload and system call trace services are offered as standard features in many operating systems, including most UNIX variants. An upcall mechanism allows a kernel resident function to return to a specific location in user mode. This is similar to the operation performed wherein a signal handler is invoked on return from a system call in a Unix system.

For example, the user mode system filter may be implemented by modifying a default library to point to a different library, which may provide a modified path to the kernel, so that the handler used by the kernel in response to receipt of the modified path accesses a capsule file instead of an OS file.

Using system service filters, there are two capabilities that are essential to enabling, for example, a software application intended to execute on one platform (hardware, OS and kernel) to execute on a different, potentially incompatible platform. These are file mapping and control of the identity supplied by the computer platform to the application. File mapping involves ensuring that a process executing in the context of a capsule uses files effectively from one of three sources:

1) the capsule file set;

2) the underlying OS; and

3) another capsule.

Identity control involves managing the values returned by the OS to an application that define values including, but not limited to: hostname, IP address, MAC address, system ID, CPU ID.

In one embodiment of the invention, file mapping is accomplished by using system service filters with all services that manipulate path names. These include, by way of example, but are not limited to, open, create, stat, fstat, lstat. In this instance, the system service filter determines where the defined file is to be located. It subsequently may use a modified path name to open the file. If a different path name is used to access any given file, this is transparent to the software application. The system service filter searches the three general locations, current capsule file set, OS, or other capsules to locate each file. The first file located in a predetermined search order is the one used by the application. In one embodiment of the invention, policy, in the form of user interaction from a command line, is used to control the search order.

In one embodiment of the invention, platform identity is managed through the use of system service filters. System services that return platform identity values that are managed through system service filters include, but are not limited to, uname, ioctl, gethostname. The system service filter modifies one or more values returned by the OS to reflect capsule values rather than OS defined values. For example, the system service uname returns a number of values from the OS that include platform identity. An example of values returned in a given Linux OS for the uname service include: system name, node name, release, version, machine. The system service filter for uname would modify the value returned for system name from that defined by the OS to a capsule specific value.

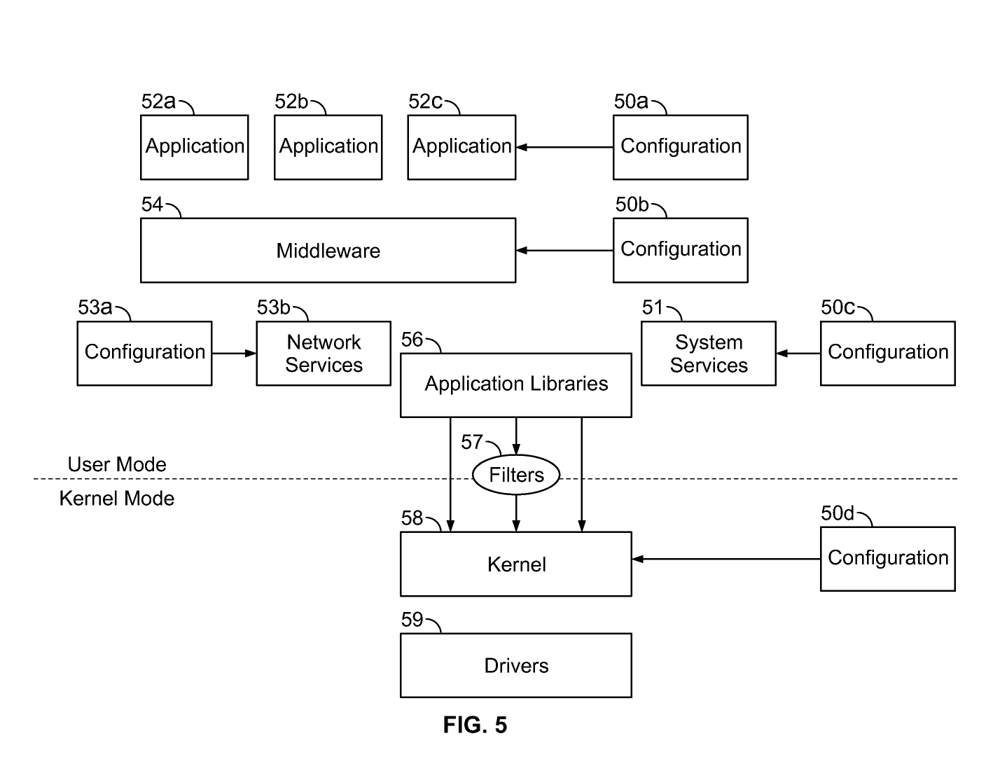

Referring now to FIG. 5, applications 52a, 52b, and 52c may be C++ applications. They may utilize middleware extended services as middleware 54. OS services are exported through application libraries 56. Application libraries 56 provide access to the kernel 58. The kernel 58 controls hardware capabilities including drivers 59. The software stack is configured as shown in 50a, 50b, 50c, 50d and 53a. Access to system services can be managed by system service filters as shown in 57.

FIG. 5 illustrates that filtered system services 57 may be a subset of those calls or requests 56 made to the kernel 58. The physical filters 57 are implementable in user mode and/or kernel mode. A kernel module may be installed to enable kernel mode services. Because filters 57 are entirely contained at not only a low-level in the application stack 56, but operate on well known interfaces, they have minimal dependency on how any given application 53a, 52b, and 52c behaves. That is, well designed filters work for virtually any application.

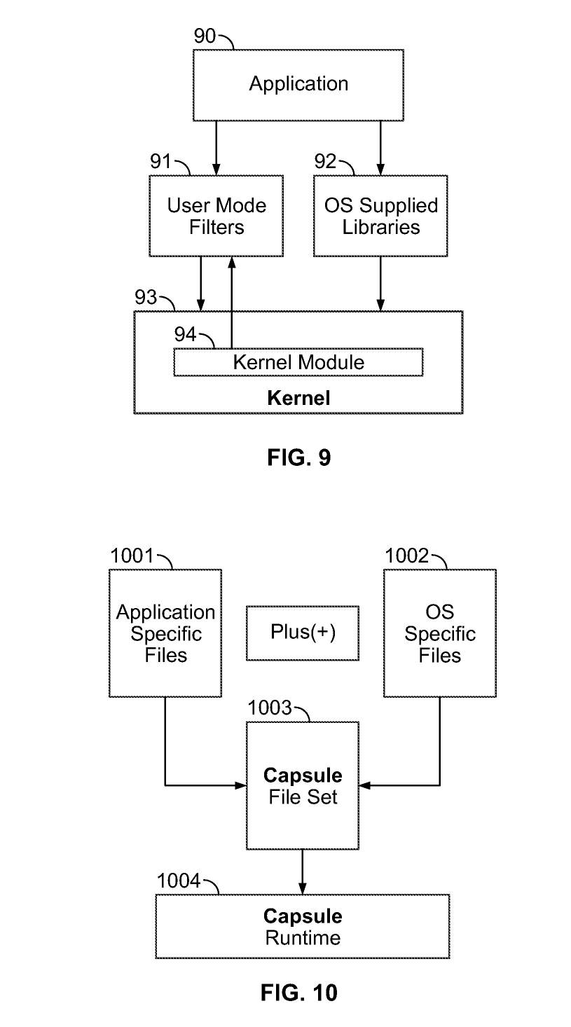

An effective system service filter design has minimal impact on the way in which the software application executes. Based on this, an application in its native form operates in essentially the same way as it does from within a capsule environment. This capability, combined with encapsulation of any files needed by an application, defines an application capsule. With this capability, virtually any application can be placed in an application capsule and made substantially independent of the underlying infrastructure. FIG. 9 illustrates a system service filter 91. It can be seen that any given system service can be filtered from within user mode 91 or kernel mode (module 94). An upcall mechanism may ensure that system services are directed to the filter in user mode when needed. System service filters shared by all capsules may be resident in the kernel module 94. In an example embodiment of the present invention, the application 90 may use OS services through the use of OS supplied application libraries 92. The kernel 93 may control the hardware. System services may be embodied in user mode (91) and/or kernel mode (94). An additional application library 91 may be utilized along with application libraries 92 supplied by the OS. The additional application library 91 may embody user mode system service filters. A kernel module 94 may be used in kernel mode. The kernel module 94 may embody kernel mode system service filters.

In an example embodiment of the present invention, for the kernel mode filter via module 94, the system and method may perform an initialization procedure upon plug-in of the capsule. The initialization procedure may be performed, e.g., only a single time at plug-in, and may affect subsequent uses of the application 90. During the initialization procedure, the system and method may change a system call table defined by the kernel 93. These changes may effectively result in installation of system service filters.

In an example embodiment of the present invention, for the user mode filter, the system and method may load the additional application library 91 upon the starting of the user mode application 90. Part of the procedure to start an application 90 includes loading libraries. Accordingly, the library 91 may be loaded when the library 92 is loaded, at the start of the application 90. This load procedure may be performed by the OS. The load procedure conducted by the OS includes the invocation of an initialization procedure for each library. The initialization of the additional application library that embodies user mode filters 91 includes the initialization and configuration of user mode system service filters. This initialization may be performed once in the lifetime of the application 90.

The common dependency for applications in a capsule is the kernel itself. This is due to the fact that an application executing within a capsule environment is able to access its own copy of any given file: executable files, library files, and configuration files. This means that any system calls made by application libraries (or embedded in application executables themselves) must be compatible with the underlying kernel on the platform used to host the capsule. Backward compatibility of system calls is normally supported by OS distributions. This allows a capsule from one version of an OS to be placed on a platform with a newer version of the same OS.

A number of variations are possible. One, in particular, will clarify usage of various OS versions. By way of example, a software application configured to operate on Solaris 8 can be placed, through an application capsule, on Solaris 10 without modification of the application itself. It should be understood that a software application within a capsule environment does not need to use files distributed with the underlying OS. A properly configured capsule file set for the Solaris 8 application will result in the application using the same files it would use on its original (Solaris 8) platform. The application can be made independent of changes in configuration, file location, and content in Solaris 10.

An example illustrating a Solaris 8 application that lists directory contents running on a Solaris 10 platform is provided. A Solaris 8 ‘ls’ program uses the libraries libc.so.1 and libm.so.1 and requires the executables /usr/bin/ls and /usr/lib/ld.so. It will access the file /var/ld/ld.config during library initialization. A capsule file set is configured to include at least the Solaris 8 files /lib/libc.so.1, /lib/libc/libm.so.1, /usr/bin/ls, /usr/lib/ld.so and /var/ld/ld.config. System service filters are installed for at least open, lstat, fstat and xstat on the Solaris 10 platform. The capsule file set is located in /usr/local/capsules/test on the Solaris 10 platform. From the Solaris 10 platform the Solaris 8 ‘ls’ application is started as a first process in a capsule as defined above. As the Solaris 8 ‘ls’ application executes and accesses the file /lib/libc.so.1 the system service filter for ‘open’ causes the file /usr/local/capsules/test/lib/libc.so.1 to be opened through modification of the pathname. This ensures that the correct file, the Solaris 8 version of libc, is used by the ‘ls’ application instead of the incompatible Solaris 10 library from the file /lib/libc. The same principal is applied to applications that require control of platform identity.

Furthermore, where there have been any customizations made to a Solaris 8 installation (e.g., additional folders added, locations altered, or file content modified), these changes can be imported and made available to the Solaris 8 application through the application capsule hosted on a Solaris 10 platform. This is simply an artifact of the application capsule ensuring that application state is kept local to the application, independent of the underlying infrastructure and other applications. In this example part of the underlying infrastructure is a Solaris 10 platform. The same principle and operation holds for movement among Linux platforms and so forth. The Solaris 8 to 10 example is particularly interesting in that both the capsule technology, and, as a result, the Solaris 8 application, can take advantage of zones and other features exported by the new OS release. A Zone is a feature provided by Sun Microsystems available in Solaris 10 that allows multiple operating system environments in a single Solaris 10 platform.

Fundamentally, an application capsule allows the application to be managed as a service. Thus, any application can be managed as a service. The application handled as a service can therefore easily be moved between computer platforms, e.g., without a new installation for each move, as well as updated independently of the OS or any other application. The service, as a capsule application, is deployed and maintained as a distinct entity.

Special handling is required to start a first application such that it is contained by way of being associated with a capsule. Subsequent applications and processes created, as a result of the first application, will be automatically associated with the capsule. The automatic association is done through tracking mechanisms based on system service filters. For example, fork, exit, and wait system calls are filtered such that capsule association can be applied to one or more applications.

In a preferred embodiment of this invention, a capsule or encapsulated file set has a physical presence prior to being installed on a compute platform. It is preferably embodied in a single file. The capsule file can reside on any storage medium as deemed necessary. The configuration state is organized in a properties file. The capsule properties file is resident within the capsule file. A capsule then includes the files used by applications associated with the capsule and configuration and state information. Configuration information includes those values which describe the capsule.

As the software application associated with or contained in a capsule is executed, it is monitored through the use of system service filters. Turning now to FIG. 6, the application 60 is shown making a system call. The system service filter 61 filters the system call before original kernel services 62 are accessed. The system service filter 61 is shown monitoring process creation, I/O activity, memory usage, and CPU usage 65. Data objects are utilized to manage the required data. A capsule data object 63 tracks all capsules in use. A process data object 64 is used to define which processes are associated with a capsule. It is shown in FIG. 6 that several operations are monitored 65. State information relative to application behavior is stored in data structures 63 and 64 and managed by the system services filter capabilities 61. The information gathered in this manner is used to track which processes are associated with a capsule, to track their aggregate hardware resource usage, and to control specific values returned to the software application. Hardware resource usage includes CPU time, memory, file activity, and network bandwidth 65.

Also monitored, as described above, is functionality associated with a given application profile. For example, applications of the type Internet browser will have to function in certain ways, creating an operation profile. The capsule-runtime (CR) software, using system service filters, is able to monitor processes executing in a capsule environment according to an application profile. The CR software will report variances that an application performs relative to a profile.

Once a set of files that are retrieved for creating a capsule, for example system files only or system and application files, a subset of the system files may be modified. The changes made to this subset may be quite diverse. Some examples of these changes are: IP address; modifying the contents of a directory to define start scripts that should be executed; modifying the contents of a file to define which mount points will relate to a capsule; removing certain hardware specific files that are not relevant in the capsule context, etc., dependent upon requirements.

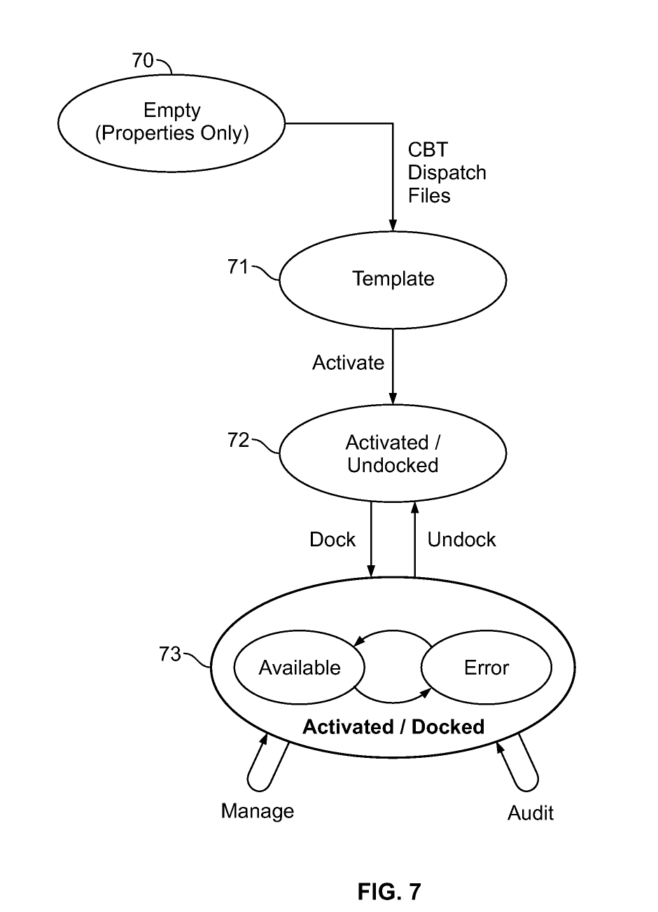

Capsule operation can be seen through a state diagram. FIG. 7 describes capsule state behavior in relation to events and commands and the action they create. An empty capsule 70 may be associated with capsule properties including, but not limited to, capsule name and capsule identifier. During the capsule creation process, files are added to the capsule. These files can be used in a template state 71. A capsule in template state 71 is used for validation purposes. When the capsule is validated, it is activated 72. The capsule files are archived and placed in a single file that is encrypted and compressed. The activated capsule 72 is ready to be deployed, but is described as undocked. Deploying a capsule is accomplished with a dock procedure. A docked capsule 73 is activated. This includes decrypting and uncompressing the capsule file. The capsule files may be placed in a directory that is part of the platform OS.

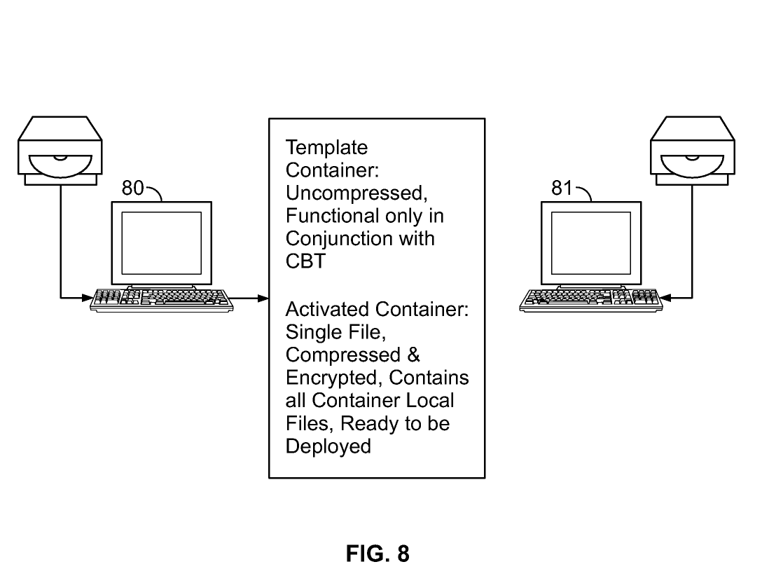

The creation and use of a capsule are summarized in the following steps. These steps refer to FIG. 8, wherein a source platform 80 embodies an application that is to be placed in a capsule. The creation tool CBT is installed on the source platform 80. A runtime platform 81 is used to host applications in capsules. A capsule runtime CR is installed on the runtime platform 81.

The steps may include: install CR on a platform 81 that will host one or more capsules; install CBT on a platform 80 that has the software application to be placed in a capsule; using CBT, define general capsule parameters, such as type, name, description, etc.; through CBT, define files to be included in the capsule, e.g., those files that will be accessed in the underlying OS and any shared files; through CBT, define capsule behavior parameters including, e.g., start/stop scripts, auto dock, identity of a virtualized capsule, etc.; CBT outputs a capsule in template state (and a properties file), where, in template state, the capsule file set is expanded and unpacked and available for use by applications or processes so as to allow processes and applications to be validated; using the capsule in the template state on the same platform 80 as CBT is installed, verify that the application functions as expected; use CBT to modify files and parameters as needed until the capsule is functional; using CBT, activate the capsule; define Digital Rights Management (DRM) details such as with which CR(s) this capsule can be docked; CBT outputs an activated capsule in a single file; copy or move the activated capsule file as required; network file storage, local disk of a CR platform 81; ensure that the platform 81 that will host the capsule can access the capsule files (copy or mount points); using the CR user interface, either a command line or GUI local to the platform where the CR is installed, or a remote management tool using one of SNMP, CIM, or SOAP, dock the capsule; use the application in the capsule as needed; using the CR user interface (as described above), extract statistics for a capsule; using the CR user interface, extract events associated with a capsule; an operational event occurs, such as maintenance being required on the computer hardware, and the capsule may be moved to another platform or placed in off line storage; using the CR user interface, undock the capsule; leave the undocked activated capsule on the platform 81 or copy/move it elsewhere as needed.

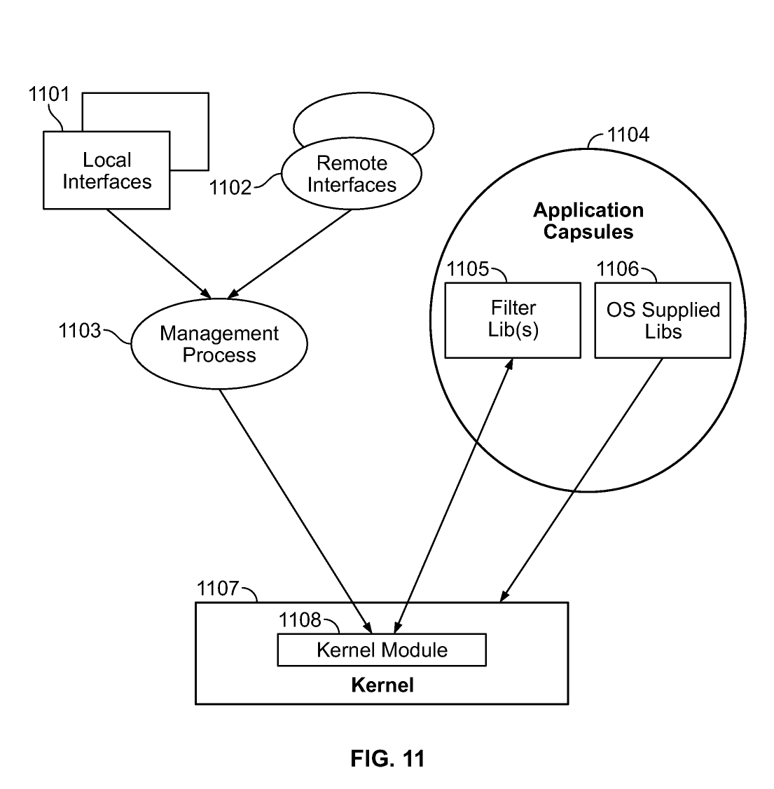

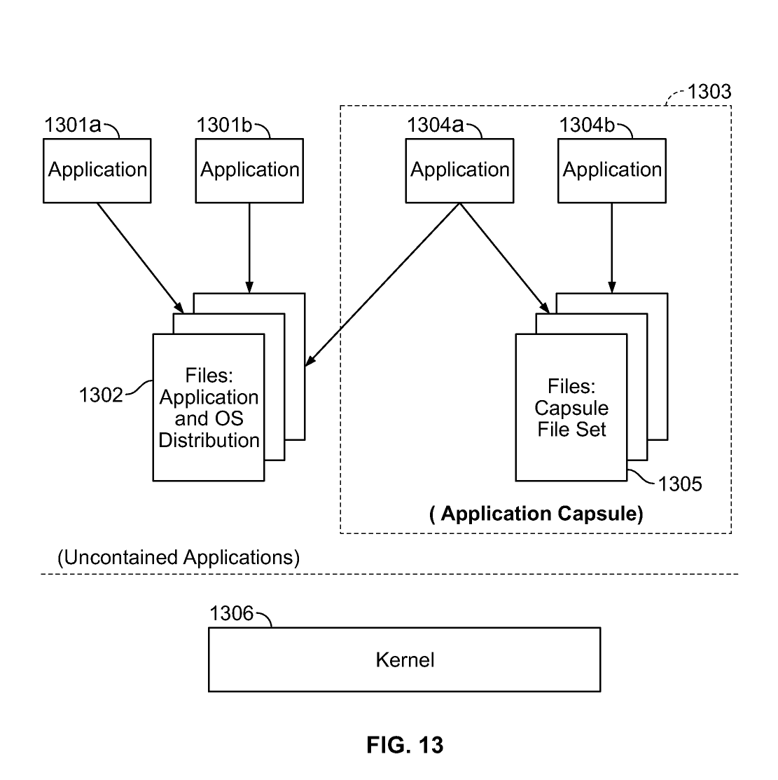

FIG. 11 is a block diagram representing the Capsule Runtime, according to an example embodiment of the present invention. It presents a process view of application capsules 1104 and their interaction with a capsule runtime 1105, 1108. A file oriented view of the application capsule 1303 can be seen in FIG. 13. An application capsule is represented in FIG. 11 as 1104, an application that utilizes one or more OS supplied application libraries 1108. A system services filter capability 1105 is supplied as part of the capsule runtime and is delivered as an application library. According to the illustrated example, portions of system services filters are performed in kernel mode and are delivered through a kernel module 1108. Both local 1101 and remote 1102 user interfaces are included. A management process 1103 is used to perform event oriented tasks associated with the user interfaces 1101, 1102.

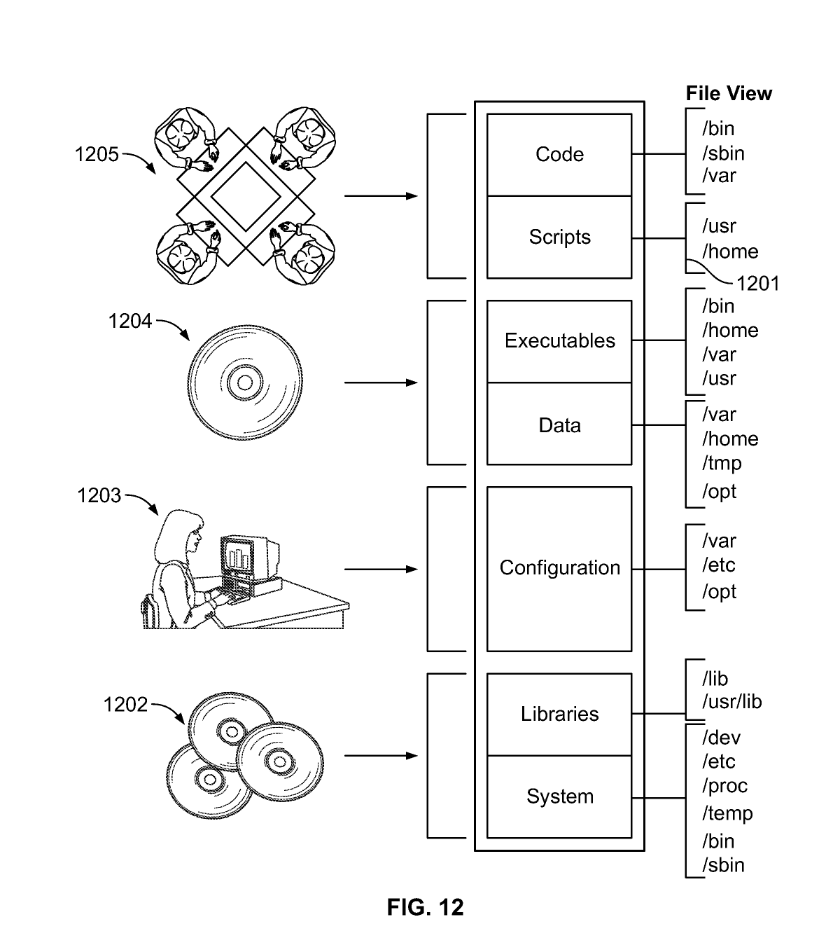

FIG. 12 illustrates the anatomy of an application revealing that an application is a composite of files 1201 on a computer platform distributed as part of an OS 1202. Configuration changes are generally applied to OS 1203 files by IT staff. Application binary files are installed, from commercial media or package files 1204, into the OS defined file system or distribution 1202. The application itself 1204 is then configured to perform a specific service in a given environment. The composite of OS files, application files, and configuration files 1201 then make up the application. In an example embodiment of the present invention, the application configuration may be performed once, e.g., by the IT staff, and the configured application may be included in a capsule for distribution to many users for execution on their respective machines in accordance with the previously performed configuration, without requiring a new configuration.

FIG. 13 presents a file oriented view of an application capsule 1303 and illustrates that one or more software applications 1304a, 1304b executing in an application capsule environment utilizes a set of files 1305 that are exclusive to the capsule. Applications outside of a capsule environment 1301a, 1301b utilize files as provided with an application and an OS distribution 1302. In an example embodiment of the present invention, it is possible, depending on specific capsule configuration elements, to allow applications in a capsule environment 1304a, 1304b to reference specific files from an underlying OS distribution 1302, outside of a capsule context. This is illustrated by the dotted line extending outside the capsule 1303. Applications 1301a and 1301b executing outside a capsule environment 1303 are not able to access files in a capsule file set 1305.

The life-cycle of a capsule and its operation is illustrated through a state diagram as shown in FIG. 7. The capsule creation process, utilizing a capsule build tool, outputs a capsule in template state 71. The capsule in this state is used to validate that the application operates as expected from within the confines of a capsule environment. Once the functionality of the application has been validated, a capsule build tool is used to activate the capsule 72. The procedure to activate a capsule includes:
1. combining all the files in the capsule file set into a single file 72; and
2. describing one or more computer platforms that are able to host the capsule.

In this state, the capsule is activated and undocked 72. Applications are deployed through the use of a capsule by docking the capsule on the one or more computer platforms, as defined by activation details 73. The procedure to dock a capsule includes:
1. validation that the capsule can be hosted, as defined by activation details; and
2. placing the files from the single capsule file into the appropriate locations so that they can be delivered to applications within the capsule environment 73.

Any errors detected by applications within the capsule environment will cause capsule state to transition from available to an error condition 73. Local and remote user interfaces support management and audit of a docked capsule 73.

In the previous embodiments described heretofore, the invention has been described in a preferred embodiment wherein containerization or encapsulation of files is required to isolate files.

Alternative embodiments of this invention also include a system wherein such isolation is not required. In embodiments wherein capsules are not required, system service filters embodied in the at least one application filter library is resident in user mode which is provided in addition to the local operating system libraries that reside in user mode. This library is loaded into memory in the same local operating system defined virtual address space as the application associated with a capsule and requesting a system service. System service filters embodied in the application filter library execute in the same local operating system defined process context as the application associated with a capsule and requesting a system service.

System service filters embodied in a kernel module are resident in the local operating system defined kernel mode. The kernel module is loaded into memory in the same local operating system defined virtual address space as the kernel. System service filters embodied in the kernel module execute in the local operating system defined kernel context.

Execution in the kernel context may imply execution in kernel mode, a privileged hardware state, rather than user mode. It may also imply that execution will use the virtual address space and scheduling rules of the kernel rather than of an application.

Those skilled in the art can appreciate from the foregoing description that the present invention may be implemented in a variety of forms. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A system for enabling a first software application, which is designed for execution on a first computer platform, to be executed on an incompatible computer platform on which the first software application is not intended to execute, the system comprising:
a hardware memory device storing a capsule environment, the capsule environment including:
a) a set of capsule-related files, comprising a first group of files that include the first software application and a second group of files that are distributed with or are specific to an operating system required to execute the first software application; and
b) capsule runtime software including a filter module; and
a processor configured to execute the first software application and run a local operating system of the incompatible computer platform, the local operating system including a local kernel;
wherein, during execution of the first software application, for performance of a task, the filter module causes the processor, via the local kernel, to access files of the second group of capsule-related files in place of local system files which are resident on the incompatible computer platform as part of the local operating system and which are otherwise used by the processor to perform the task.

2. A system as defined in claim 1, wherein the capsule runtime software, when executed, manages a dynamic state and file location of the first software application.

3. A system as defined in claim 1, wherein the capsule environment includes an execution file associated therewith for starting one or more applications therewithin.

4. A system as defined in claim 3, wherein the execution file includes instructions related to an order in which executable applications within the capsule environment will be executed.

5. A system as defined in claim 1, wherein the set of capsule related files are stored in a single file.

6. A system as defined in claim 1, wherein a plurality of capsule environments are provided.

7. A system as defined in claim 1 wherein:
the first software application includes one or more application binary files which utilize application libraries and application configuration information;
the first group of files includes a filter library for communicating with the local kernel; and
the filter module causes the application libraries to redirect an access thereto to the filter library.

8. A system as defined in claim 7, wherein, in response to some accesses to the application libraries, the application libraries request services from the local kernel directly without redirection to the filter library.

9. A system as defined in claim 1 wherein the set of capsule-related files are limited to a segregated file name space.

10. A system as defined in claim 1, wherein, in operation, the run-time software manages a dynamic application state, and the filter module filters system service requests in accordance with the dynamic application state.

11. A system as defined in claim 1, wherein the filter module at least one of:
a) tracks processes by identifying for each process whether the process is associated with a particular capsule environment or with the operating system;
b) tracks resources used by processes executing within a capsule environment; and
c) modifies values returned by system services for providing isolation of files within a capsule environment.

12. A system as defined in claim 1, wherein the filter module is used in both kernel mode and user mode, and wherein the filter module allows processes executing within the capsule environment to be tracked.

13. A system as defined in claim 1, wherein:
the filter module includes instructions, which, when executed, cause the processor to update a table accessed by the local kernel for calling a system call handler to include a pointer to a filter handler instead of the system call handler; and
in response to a request by the first software application to the local kernel for a file, the local kernel accesses the modified table, causing the filter handler to be implemented, the filter handler passing modified values to the system call handler, the system call handler responsively accessing a file of the second group of capsule-related files.

14. A system as defined in claim 1, wherein:
the second group of files includes application libraries;
the first group of files includes a filter library for communicating with the local kernel; and
the filter module causes the application libraries to redirect a request addressed thereto to the filter library.

15. A system for enabling a first software application, which is designed for execution on a first computer platform, to be executed on an incompatible computer platform on which the software application is not intended to execute, said system comprising:
a computer-readable medium having stored thereon:
a first group of files that are distributed with or are specific to the first software application intended to run on the first computer platform;
a second group of files that are distributed with or are specific to an operating system of the first computer platform, the first group of files being stored in a manner that isolates the first group of files from the other software applications;
capsule runtime software including a filter module; and
an operating system; and
a processor configured to execute the first software application using the operating system, wherein, during execution of the first software application to perform a task, the filter module causes the processor to access isolated first group of files in place of files of the operating system otherwise used by the processor to perform the task.

16. The system of claim 15, wherein:
the filter module includes instructions, which, when executed, cause the processor to update a table accessed by a local kernel of the operating system for calling a system call handler to include a pointer to a filter handler instead of the system call handler; and
in response to a request by the first software application to the local kernel for a file, the local kernel accesses the modified table, causing the filter handler to be implemented, the filter handler passing modified values to the system call handler, the system call handler responsively accessing a file of the first group of files.

17. A system as defined in claim 15, wherein:
the second group of files includes an application library and a filter library for communicating with a local kernel of the operating system; and
the filter module causes the application library to redirect a request addressed thereto to the filter library.

18. A system for minimizing installation requirements for a software application, comprising:
a hardware memory device storing a capsule environment, the capsule environment including:
a) a set of capsule-related files, comprising a software application and a group of files; and
b) capsule runtime software including a filter module;
wherein, during execution of the software application by a processor, for performance of a task, the filter module causes the processor, via a local kernel of an operating system used by the processor for execution of the software application, to access the group of files in place of local system files which are resident on a computer platform as part of the operating system and which are otherwise used by the processor to perform the task.

19. The system of claim 18, wherein:
the filter module includes instructions, which, when executed, cause the processor to update a table accessed by the local kernel for calling a system call handler to include a pointer to a filter handler instead of the system call handler; and
in response to a request by the software application to the local kernel for a file, the local kernel accesses the modified table, causing the filter handler to be implemented, the filter handler passing modified values to the system call handler, the system call handler responsively accessing a file of the group of files.

20. A system as defined in claim 18, wherein:
the capsule-related files include an application library and a filter library for communicating with the local kernel; and
the filter module causes the application library to redirect a request addressed thereto to the filter library.

21. A method for reducing installation requirements for a software application comprising:
providing a hardware memory device storing a capsule environment, the capsule environment including:
a) a set of capsule-related files, comprising a software application and a group of files; and
b) capsule runtime software including a filter module;
wherein, during execution of the software application by a processor, for performance of a task, the filter module causes the processor, via a local kernel of an operating system used by the processor for execution of the software application, to access the group of files in place of local system files which are resident on a computer platform as part of the operating system and which are otherwise used by the processor to perform the task.

22. A method for performing a task for a software application, comprising:
in response to a request by the software application for a local system file of an operating system used for execution of the software application, redirecting the request to access a file stored in a capsule environment together with the software application;
wherein the redirecting includes at least one of:
updating a table, which a local kernel of the operating system accesses for calling a system call handler, to include a pointer to a filter handler instead of the system call handler, the filter handler, when implemented, passing modified values to the system call handler; and
causing an application library to redirect a request thereto to a filter library for communicating with the local kernel.

23. A computer-readable medium having stored thereon instructions, the instructions which, when executed, cause a processor to perform a method that facilitates running a software application with minimized installation requirements, the method comprising:
in response to a request by the software application for a local system file of an operating system used for execution of the software application, redirecting the request to access a file stored in a capsule environment together with the software application;
wherein the redirecting includes at least one of:
updating a table, which a local kernel of the operating system accesses for calling a system call handler, to include a pointer to a filter handler instead of the system call handler, the filter handler, when implemented, passing modified values to the system call handler; and
causing an application library to redirect a request thereto to a filter library for communicating with the local kernel.
